(19) United States
(12) Patent Application Publication
(10) Pub. No.: US 2017/0315527 A1
(43) Pub. Date: Nov. 2, 2017

(54) Textile Machine and Method for Operating the Same

(71) Applicant: Rieter Ingolstadt GmbH, Ingolstadt (DE)

(72) Inventor: Stephan Weidner-Bohnenberger, Ingolstadt (DE)

(21) Appl. No.: 15/581,961

(22) Filed: Apr. 28, 2017

(30) Foreign Application Priority Data
Apr. 29, 2016 (DE) 10 2016 107 994.4

(51) Int. Cl. G05B 19/048

(52) U.S. Cl. CPC G05B 19/048; G05B 2219/24001; G05B 2219/24019

(57) ABSTRACT

The invention relates to a method for operating a textile machine (1) with a multiple number of similar work stations (2), whereas, with the assistance of work stations (2) during normal operation, yarn is produced or is rewound from a delivery coil onto a receiving coil, and whereas normal operation at the individual work stations (2) is interrupted at certain time intervals and is resumed with the assistance of a maintenance operation, and whereas the maintenance operations are carried out by one or more maintenance devices (3). In accordance with the invention, it proposed that for each work station (2), one or more production-related parameters are known or are determined, and that if more maintenance operations are to be carried out simultaneously than can be carried out by the maintenance devices(s) (3), the selection of the work station (2) to be serviced next will then be made under consideration of such production-related parameters, in such a manner that an upcoming batch change is completed as early as possible.

This invention relates to a method for operating a textile machine with a multiple number of similar work stations, whereas, with the assistance of work stations during normal operation, yarn is produced or is rewound from a delivery coil onto a receiving coil, and whereas normal operation at the individual work stations is interrupted at certain time intervals and is resumed with the assistance of a maintenance operation, whereas the maintenance operations are carried out by one or more maintenance devices.

Furthermore, the invention relates to a textile machine with a multiple number of similar work stations for producing yarn or for rewinding yarn from a delivery coil onto a receiving coil, with one or more maintenance devices.

Textile machines conforming to this type include both winding machines and spinning machines, for example ring, rotor or air spinning machines Usually, such textile machines feature a multiple number of similar work stations.

In normal operation, the winding machines wind yarn from a delivery coil onto a receiving coil, thereby preferably removing yarn defects from the yarn. In normal operation, spinning machines produce yarn from a supplied fiber composite.

Normal operation of such textile machines can be interrupted at certain time intervals. One reason for such an interruption is a so-called “yarn breakage”; that is, the tearing of the yarn to be produced or rewound. An additional reason for an interruption of normal operation is the intentional cutting out of a defective yarn section, a so-called “clearer cut.” This can be carried out if the yarn does not have the desired quality, for example because it is too thick, too thin or too dirty. An interruption of normal operation also arises if, at one work station, the delivery coil or the coil or canister providing the fiber composite is empty and has to be exchanged for a complete delivery coil, or coil or canister, as the case may be, or if a predetermined quantity is wound on the receiving coil that accepts it. Depending on the textile machine and the reason for the interruption, in principle, there are three options for how the respective work stations can resume normal operation—in the best case, each individual work station has a maintenance device and is thus automated to the extent that it itself can undertake the steps necessary to resume normal operation. However, such work station automation is usually economically viable only for the elimination of the most frequently occurring interruptions, in particular the aforementioned clearer cuts. In order to remedy a multiple number of the remaining interruptions, mobile maintenance devices are provided; that is, robots that drive or are driven to the relevant work stations, and then carry out a maintenance operation; that is, they take the necessary steps so that the work station can resume normal operation. Finally, in certain, more complicated cases, it may be necessary to restore normal operation of the work station by operating personnel.

With the present invention, particularly those interruptions of normal operation with which a maintenance device restores normal operation of the work stations are of interest. Thereby, it may occur that more maintenance operations are to be carried out simultaneously than can be carried out by the maintenance device(s), because, for example, only a limited number of maintenance devices are available or because energy resources, such as electricity, compressed air or negative pressure, are only available to a limited extent. In this case, various strategies for processing the maintenance operations are pursued—thus, the maintenance operations can be carried out according to the chronological sequence of the occurrence of the interruption. Or, the mobile maintenance devices drive along a series of work stations and carry out a maintenance operation at the work stations at which normal operation is interrupted. More efficient methods also take into account, for example, the travel paths and/or times of the mobile maintenance devices, in order to improve the productivity of the textile machine.

The task of this invention is to design the sequence of the processing of the maintenance operations more efficiently, and thus further improve the productivity of the textile machine.

The task is achieved by a method for operating a textile machine along with a textile machine with the characteristics of the independent claims.

A method is proposed for operating a textile machine with a multiple number of similar work stations is proposed. Thereby, with the assistance of the work stations, yarn is produced during the normal operation of the work stations, or is rewound from a delivery coil onto a receiving coil. Thus, the textile machine comprises a spinning machine, for example a ring, rotor or air spinning machine, or a winding machine.

Normal operation of the work stations is interrupted at certain time intervals, for example on the basis of a yarn breakage, a clearer cut or an empty delivery coil, coil or canister, as the case may be. It is then resumed with the assistance of a maintenance operation. Depending on the reason for the interruption of normal operation, this can be, for example, a setting operation, with which a yarn end is set at an empty or already partially spooled coil, a yarn joining operation, also called a splicing operation, with which two yarn ends are connected to each other, or a coil or canister exchange operation.

Within the meaning of this invention, those maintenance operations that are carried out by one or more maintenance devices are of particular interest. Such maintenance devices drive to the work station, which requires a maintenance operation, or are driven to the work station. There, they then automatically carry out the maintenance operation, and then drive to the next work station or are driven to it. Thereby, the sequence in which the work stations are approached and the maintenance operations are processed is usually determined by a central control unit.

In accordance with the invention, for each work station, one or more production-related parameters are known, or the production-related parameters are determined. If more maintenance operations are to be carried out simultaneously than can be carried out by the maintenance devices(s), the selection of the work station to be serviced next will then be made under consideration of such production-related parameters, in such a manner that an upcoming batch change is completed as early as possible. Thereby, a batch change is the conversion of production to the production or rewinding of a different yarn; that is yarn with other properties, such as material, thickness, twist or surface treatment. If the upcoming batch change is now completed at an early stage, all work stations can begin with the production or rewinding of the new yarn at an early stage, such that the productivity of the entire textile machine is increased.

Advantageously, production progress, the expected production speed and/or the expected maintenance operations are known or are determined as production-related parameters. Production progress is generally known, or can be readily determined by a measurement on the produced coil. Moreover, the expected production speed can also be easily determined, for example, as the average value of the production speed over a certain period of time. It is also possible to determine the expected maintenance operations at the respective spinning stations from the maintenance operations that have occurred for a certain period of time.

With the assistance of such production-related parameters, the expected production of the individual work stations can be determined; for example, the expected completion of the currently produced or rewound coil. With the assistance of such information, the processing of the maintenance operations by the maintenance devices can then be controlled, in such a manner that an upcoming batch change is completed as early as possible, and the productivity of the textile machine is thus increased.

It is advantageous if the batch change is carried out on all or only at a part of the work stations of the textile machine. Thus, the best possible and most efficient solution can always be found, depending on the order size and/or the options of the textile machine; that is, the extent to which it supports the production of different threads at parts of the work stations.

In order to determine the best possible sequence of the processing of the maintenance operations, it is advantageous if each work station is assigned with a desired time by which the work station ideally should have completed the current production. This desired time is then targeted as the goal upon the processing of the maintenance operations.

It is advantageous if each work station is assigned with the same desired time. This is particularly advantageous for textile machines, with which the doffing, that is, the exchange of the coils, and thus also the batch change, takes place at all work stations at the same time. In this case, it is obvious that the highest productivity of the textile machine is achieved if the work stations complete their current production as much as possible at the same time. This prevents individual work stations from being at a standstill for a long time while they wait for the other work stations to be finished and the batch change to be carried out.

For textile machines with which the batch change does not take place for all work stations at the same time, but is carried out separately by one or more doffing robots for each work station, a common desired time for all work stations is not the optimum solution. Rather, in this case, it is advantageous if a planned timetable of the doffing robot (s) is initially generated. This timetable features exactly one stop from one of the doffing robots for each work station, and is preferably generated under consideration of the production-related parameters of the work stations—work stations that are expected to be finished later are only approached later by the doffing robot in accordance with the planned timetable. Subsequently, a desired time is assigned to each work station; this corresponds to the stop of the doffing robot at such work station according to the planned timetable. Thus, such desired times also take into account the batch change by the doffing robot(s), and thus contribute to the increase in the productivity of the textile machine.

It is advantageous if, for each work station, the expected completion time until which the work station is expected to have completed the current production is determined taking into account the production-related parameters. Thus, this is the expected completion time without taking into account the upcoming batch change. In order to take into account the upcoming batch change, the greater the difference between the expected completion time and the desired time, a higher priority is given to the maintenance priority for carrying out a maintenance operation at a work station. Thereby, it is also possible that this difference is negative, and thus the maintenance priority of the relevant work station is reduced. Thus, the work stations that have to catch up time in comparison to the other work stations are preferably treated with respect to the carrying out of the maintenance operations, while work stations that are ahead of the schedule are disadvantaged during the carrying out of the maintenance operations. As a whole, this results in a more efficient use of available resources.

Advantageously, the desired times for the work stations are newly determined taking into account the maintenance priorities, whereas if necessary—likewise taking into account the maintenance priorities—the planned timetables of the doffing robots are newly generated. In addition, the expected completion times are newly determined taking into account the maintenance priorities. On the basis of the newly determined desired times and the expected completion times, new maintenance priorities are set, which in turn become higher, the greater the difference between the expected completion time and the desired time. With the maintenance priorities that are thus adjusted, the available resources are utilized even better, and the productivity of the textile machine is thus further increased.

This can be further improved by repeating the process steps indicated above iteratively; that is, by determining new desired times and new expected completion times taking into account the new maintenance priorities, and the difference between such dates leading to even newer maintenance priorities. In doing so, the number of iterations steps can be fixed, or as many iterations can be carried out until the increase in productivity from one iteration step to the next iteration step falls below a certain value.

If the difference between the expected completion time and the desired time exceeds a first predetermined value or falls below a second predetermined value, it is advantageous if the production speed at such work stations is occasionally increased or decreased. By occasionally increasing the production speed at individual work stations, the productivity of the textile machine can be increased by accepting, for example, the associated higher energy consumption. By contrast, by occasionally reducing the production speed, energy (for example) can be saved, and/or the probability of yarn breakages can be reduced, which in turn is beneficial to the overall cost-effectiveness or productivity of the textile machine.

Finally, it is advantageous if the batch change is carried out even if individual work stations have not yet completed the current production, to the extent that this is advantageous for the productivity of the textile machine. This can be the case, for example, if an interruption in normal operation occurred at one or a few work stations after the initiation of the batch change, which has resulted in maintenance by the operating personnel, and such maintenance cannot be carried out promptly. Then, with the progress of production, such work station(s) is/are located far behind the other work stations, and it would be disadvantageous for the productivity of the textile machine if the batch change were to wait for such work station(s).

The specified method is carried out according to the preceding description, whereas the specified features can be realized individually or in any desired combination.

A textile machine with a multiple number of similar work stations for producing yarn or for rewinding yarn from a delivery coil onto a receiving coil is also proposed. Thus, the textile machine comprises a spinning machine, for example a ring, rotor or air spinning machine, or a winding machine. Furthermore, the textile machine features one or more maintenance devices. Such maintenance devices are formed to automatically carry out maintenance operations, for example setting operations, yarn joining operations, or coil or canister exchange operations occurring at the individual work stations. For this purpose, the maintenance devices can drive to or are driven to the work stations.

In accordance with the invention, the textile machine features a control unit or is in operative connection with a control unit. Thereby, the control unit is designed in such a manner that it operates the textile machine according to the method described above. In particular, the control unit selects the work station to be serviced next, such that an upcoming batch change is completed as early as possible. This increases the overall productivity and cost-effectiveness of the textile machine.

Additional advantages of the invention are described in the following embodiment. The following is shown:

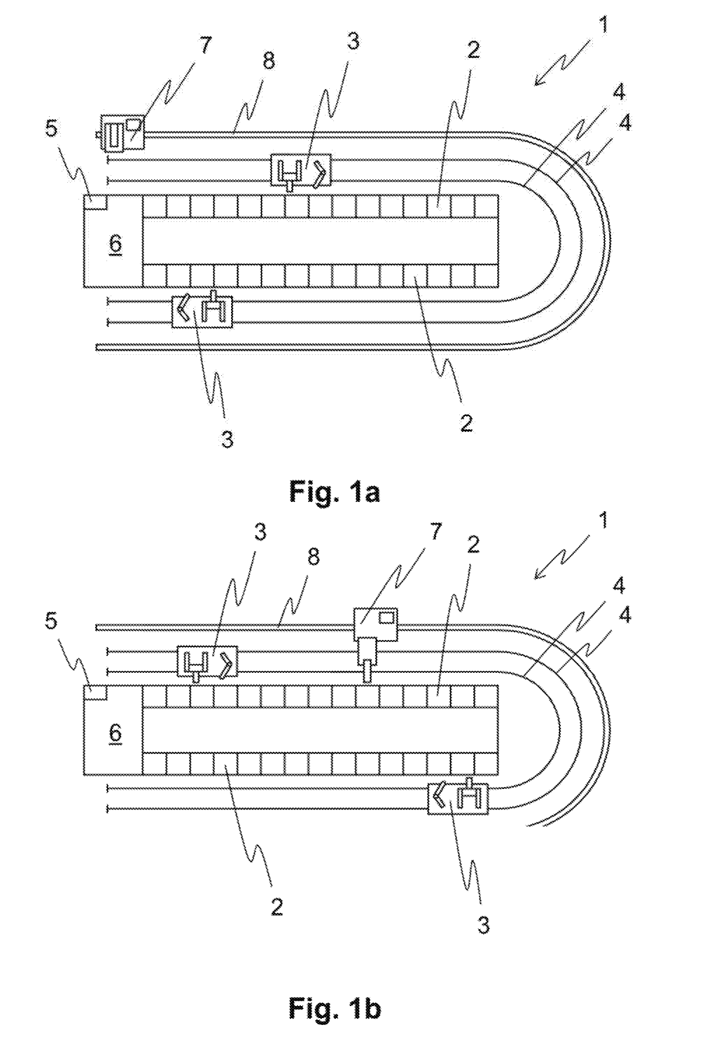

FIG. 1a a schematic top view of a textile machine in accordance with the invention,

FIG. 1b a schematic top view of a textile machine from FIG. 1a during a batch change and

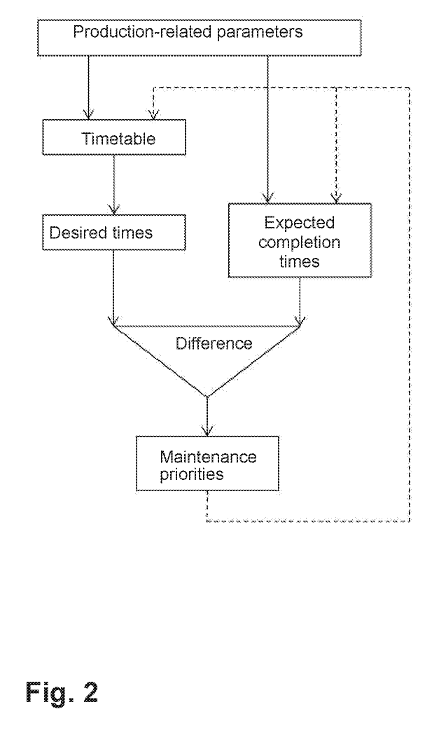

FIG. 2 a flow chart for the determination of maintenance priorities.

FIG. 1a shows a textile machine 1 in accordance with the invention with a multiple number of work stations 2 (whereas, for the sake of clarity, only two of which are provided with a reference sign). Each of such work stations 2 is formed to, during normal operation, produce yarn or rewind yarn from a delivery coil onto a receiving coil. Thus, the textile machine 1 comprises a spinning machine, for example a ring, rotor or air spinning machine, or a winding machine.

Furthermore, the textile machine 1 features two maintenance devices 3. If an interruption of normal operation occurs at a work station 2, the maintenance devices 3 can drive on rails 4 to such work station 2 and continue normal operation at such work station 2 with the assistance of a maintenance operation. The possible maintenance operations include, for example, setting operations, with which a yarn end is set at an empty or only partially spooled coil, yarn joining operations, with which two yarn ends are connected to each other, or coil or canister exchange operations, with which an empty delivery coil or an empty canister is exchanged for a full coil or canister.

The maintenance devices 3 are controlled by a central control unit 5, which can be located at a machine end 6 of the textile machine 1. If more maintenance operations are to be carried out simultaneously than can be carried out by the maintenance devices 3, the control unit 5 selects the work station 2 to be serviced next, taking into account the production-related parameters of the work station 2 and the travel paths and times of the maintenance devices 3, in such a manner that the productivity of the textile machine is maximized.

Furthermore, the control unit 5 controls a doffing robot 7, which can drive on the rails 8 to the individual work stations 2. In the case of a batch change (that is, a change to the production of yarn with other properties such as, for example, material, thickness, spin or surface treatment), the doffing robot 7 exchanges the coils. In FIG. 1a, no batch change takes place and the doffing robot 7 is located at one end of the rails 8 in a parking position.

The rail bows of the rails 4 and the rails 8 shown here enable the maintenance devices 3 or the doffing robot 7, as the case may be, to reach work stations 2 on both machine sides. Such rail bows are optional and may also be omitted for reasons of costs or space. In this case, at least one maintenance device 3 or at least one doffing robot 7 are required per machine side. The maintenance device 3 or the doffing robot 7 can then also only be scheduled for the machine side by the control unit 5 that is assigned to the maintenance device or doffing robot.

FIG. 1b shows the textile machine 1 from FIG. 1a during a batch change. The doffing robot 7 is now in operation and carries out the batch change at such work stations 2 that have already finished current production. Meanwhile, at the other work stations 2, the production of threads with the original characteristics continues. If interruptions in normal operation occur at such work stations 2, the control unit 5 instructs a maintenance device 3 to carry out a maintenance operation on the work station 2 so that the work station 2 can resume normal operation.

If more maintenance operations have to be carried out simultaneously than can be carried out by the maintenance devices 3, the control device 5 selects the work station 2 to be serviced next, taking into account the production-related parameters of the work stations 2, in such a manner that the batch change is completed as early as possible, and the productivity of the textile machine 1 is thus increased. Thereby, the production-related parameters are production progress, the expected production speed and the expected maintenance operations. They are preferably determined by the control unit 5 on an ongoing basis for all work stations 2.

The selection of the work station 2 to be serviced next is explained with reference to a flow chart shown in FIG. 2. Taking into account the production-related parameters, the control unit 5 generates an expected timetable for the doffing robot 7. In doing so, the doffing robot 7 serves each work station 2 exactly once. The stops of the doffing robot 7 at each work station 2 are set as the desired times for the respective work station 2.

Taking into account the production-related parameters, the expected completion times for the individual work stations 2 are also calculated. The difference between the expected completion time and the desired time is then formed for each work station 2. On the basis of such difference, the maintenance priorities for the work stations 2 are set, and the higher the difference, the higher the maintenance priorities.

In order to further improve the determination of the maintenance priorities and thus to complete the batch change even earlier, the timetable of the doffing robot 7, the resulting desired times and the expected completion times are newly defined with further consideration of the maintenance priorities just defined. This is indicated in FIG. 2 by the dashed lines. The difference between the expected completion time and the desired time is then newly calculated, and the maintenance priorities are updated accordingly.

This procedure is repeated iteratively until a predetermined number of iterations is reached, or until the improvement in productivity from one iteration step to the next iteration step falls below a predetermined value.

This invention is not limited to the described embodiment and can be modified within the scope of the claims.

### LIST OF REFERENCE SIGNS

1 Textile machine
2 Workstations
3 Maintenance devices
4 Rails
5 Control unit
6 Machine end
7 Doffing robot
8 Rails

1. Method for operating a textile machine (1) with a multiple number of similar work stations (2),
whereas, with the assistance of work stations (2) during normal operation, yarn is produced or is rewound from a delivery coil onto a receiving coil, and
whereas normal operation at the individual work stations (2) is interrupted at certain time intervals and is resumed with the assistance of a maintenance operation, and
whereas the maintenance operations are carried out by one or more maintenance devices (3), characterized in that
for each work station (2), one or more production-related parameters are known or are determined, and that, if more maintenance operations are to be carried out simultaneously than can be carried out by the maintenance devices(s) (3), the selection of the work station (2) to be serviced next will then be made under consideration of such production-related parameters, in such a manner that an upcoming batch change is completed as early as possible.

2-11. (canceled)
